(19) United States
(12) Patent Application Publication
(10) Pub. No.: US 2022/0143743 A1
(43) Pub. Date: May 12, 2022

(54) WORKING DISTANCE MEASUREMENT FOR ADDITIVE MANUFACTURING

(71) Applicant: FORMALLOY TECHNOLOGIES, INC., Spring Valley, CA (US)

(72) Inventor: Jeffrey L. RIEMANN, Spring Valley, CA (US)

(21) Appl. No.: 17/094,611

(22) Filed: Nov. 10, 2020

(51) Int. Cl. B23K 26/03; B33Y 10/00; B33Y 30/00; B33Y 50/02; B23K 26/342

(52) U.S. Cl. CPC B23K 26/032; B33Y 10/00; B23K 26/0626; B33Y 50/02; B23K 26/342; B33Y 30/00

(57) ABSTRACT

Certain aspects of the present disclosure provide a method of operating an additive manufacturing system, including: receiving image data from a camera sensor positioned such that its field of view includes a reference location on a deposition element of the additive manufacturing system and an active processing area; determining a location of the active processing area based on the image data received from the camera sensor; and determining one or more process parameters based on the determined location of the active processing area and the reference location on the deposition element.

### INTRODUCTION

The present disclosure relates to additive manufacturing systems and methods. In particular, aspects of the present disclosure relate to systems and methods for measuring working distance between an active processing area and a deposition element during an additive manufacturing process.

Examples of commercially available additive manufacturing methods include extrusion-based methods (e.g., Fused Deposition Modeling (FDM)), fusing or binding from a powder bed based methods (e.g., Selective Laser Sintering (SLS), Selective laser melting (SLM), and Electron beam melting (EBM)), lamination methods, photopolymerization methods (e.g., stereo lithography), powder- or wire-fed directed energy deposition methods (e.g., direct metal deposition (DMD), laser additive manufacturing (LAM), laser metal deposition (LMD)), and others.

Laser metal deposition (LMD) is a laser-based additive manufacturing process in which metal structures are built up on a substrate or metal layers and structures are applied to existing components (e.g., cladding) in layers. In LMD, a laser generates a molten bath on an existing surface into which metal powder is directed through a nozzle in a deposition head (e.g., using a carrier gas). The powder melts and bonds with the base material in the molten pool thereby forming new layers and ultimately structures additively.

A challenge with additive manufacturing, such as laser metal deposition, is properly setting and maintaining the distance between a deposition element of the additive manufacturing machine and an active processing area on a substrate or part layer upon which new material is being deposited, which may be referred to as a working distance. For example, in laser metal deposition, the distance between the deposition head and the melt pool needs to be carefully maintained during a build process so that a focal point of a directed energy beam, a focal point for the powder flow, and a build surface all converge. When the working distance diverges from the optimum, the build quality of the additive manufacturing process may suffer due to, for example, irregular layer thickness, wasted material, uneven heating, and the like.

Conventionally, working distance between a deposition element and the active processing area may be estimated based on a control system's estimate of the location of a deposition head relative to a build surface, such as a substrate, and/or one or more already deposited layers of a part being manufactured. However, as a normal build progresses, even small irregularities (e.g., in layer thickness) propagated over many layers can lead to significant positioning error, which then leads to more build irregularities, and so on.

Accordingly, what is needed are improved systems and methods for actively determining the working distance between a deposition element and an active processing area during additive manufacturing.

### BRIEF SUMMARY

A first aspect provides an additive manufacturing apparatus, including: a process motion system configured to move in a plurality of degrees of freedom; a deposition assembly connected to the process motion system and comprising a deposition element; a working distance measurement assembly attached to the deposition assembly; and a controller configured to control operation of the additive manufacturing apparatus, wherein: the working distance measurement assembly comprises a camera sensor positioned such that its field of view includes a reference location on the deposition element and an active processing area, the controller is configured to determine a location of the active processing area based on image data received from the camera sensor, and the controller is further configured to determine one or more process parameters based on the determined location of the active processing area and the reference location on the deposition element.

A second aspect provides a method of operating an additive manufacturing system, including: receiving image data from a camera sensor positioned such that its field of view includes a reference location on a deposition element of the additive manufacturing system and an active processing area; determining a location of the active processing area based on the image data received from the camera sensor; and determining one or more process parameters based on the determined location of the active processing area and the reference location on the deposition element.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of an additive manufacturing system.

FIG. 2 depicts an example of a material delivery system.

FIG. 3 depicts an example of an additive manufacturing machine with a working distance measurement system.

FIGS. 4A and 4B depict further aspects of determining a working distance between a deposition element and an active processing area.

FIGS. 4C and 4D depicts aspects of determining a relative working distance based on changes in active processing area location in a fixed field of view.

FIGS. 5A and 5B depict examples of working distance errors that may be mitigated by active working distance measurements.

FIG. 6 depicts aspects of control system configured for measuring working distance and acting upon measured working distance.

FIG. 7 depicts an example method of operating an additive manufacturing system with a working distance measurement system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for measuring a working distance of an additive manufacturing process, such as between a deposition element and an active processing area.

Maintaining a proper working distance between a deposition element (e.g., a deposition head of a laser metal deposition system) and an active processing area (e.g., the melt pool created by laser metal deposition) is an important aspect to improving the quality of a part being built by an additive manufacturing system.

Some conventional methods of measuring the working distance require optical sensors arranged coaxially with a directed energy beam so that they can “look down” on the active processing area from above and estimate the distance. Such methods may be error prone, however, because the sensor's view and/or projected beam may be interfered with by the environment of an active processing area, such as by material flows (e.g., powder flows) that reflect sensor light and induce errors in measurements. Further, coaxial sensors may be subjected to directed energy backscatter and other damaging environmental conditions, which reduce the life and accuracy of the sensors, and make packaging more difficult. Common to these conventional “look down” configurations are a lack of visual perspective of the actual working distance, e.g., the space between a deposition element and the active processing area.

Other conventional methods may use contactless or contact-based sensors that generally measure the deposited material height, but such methods must be done while the deposition has paused thus making the measurement less efficient.

Embodiments described herein use a working distance measurement system with a camera laterally offset from a deposition assembly in order to provide a “look from the side” field of view. Being laterally offset from the deposition assembly provides several advantages, including a better perspective of the actual distance between the deposition element and the active processing area, less sensor obstruction from material flows, and less exposure to high heat and high energy components of the additive manufacturing system. Further, the use of a camera-based systems allows for leveraging computer-vision for determining various process parameters related to the active processing by the additive manufacturing system.

### Example Additive Manufacturing System

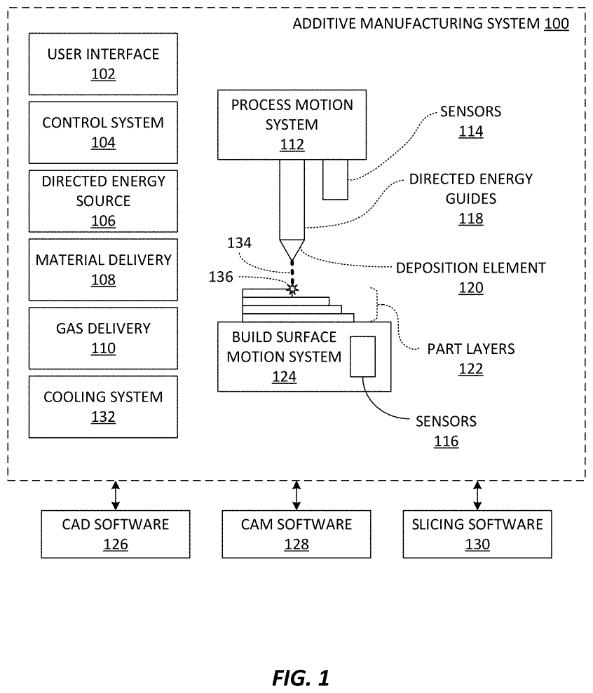

FIG. 1 depicts an example of an additive manufacturing system 100.

In this example, additive manufacturing system 100 includes a user interface 102. User interface 102 may be, for example, a graphical user interface comprising hardware and software controls for controlling additive manufacturing system 100. In some examples, user interface 102 may be integral with additive manufacturing system 100 while in other examples user interface 102 may be remote from additive manufacturing system 100 (e.g., on a remote computer such as a server computer, desktop or laptop computer, or a personal electronic device, such as a smartphone, tablet computer, or a smart wearable device, to name a few examples).

Additive manufacturing system 100 also includes a control system 104. In this example, control system 104 is in data communication with user interface 102 as well as directed energy source 106, material delivery system 108, gas delivery system 110, process motion system 112, sensors 114, sensors 116, build surface motion system 124, and cooling system 132. In other examples, control system 104 may be in data communication with further elements of additive manufacturing system 100, which are not depicted in this example. Further, in other examples, control system 104 may be in data communication with fewer elements of additive manufacturing system 100, such as where another embodiment of an additive manufacturing system includes fewer elements compared to the example of FIG. 1.

Control system 104 may include hardware and software for controlling various aspects of additive manufacturing system 100. For example, control system 104 may include one or more processors, memories, data storages, physical interfaces, software interfaces, software programs, firmwares, and other aspects in order to coordinate and control the various elements of additive manufacturing system 100. In some examples, control system 104 may include network connectivity to various aspects of additive manufacturing system 100 as well as to external networks, such as the Internet and other networks, such as local area networks (LANs) and wide area networks (WANs). In some examples, control system 104 may be a purpose-built logic board, microcontroller, field programmable gate array (FPGA), or the like, while in other examples control system 104 may be implemented by a general purpose computer with specific software components for controlling the various aspects of additive manufacturing system 100.

Control system 104 may generally interpret commands received from user interface 102 and thereafter cause appropriate control signals to be transmitted to other aspects of additive manufacturing system 100. For example, a user may input data representing a part to be processed using additive manufacturing system 100 into user interface 102 and control system 104 may act upon that input to cause additive manufacturing system 100 to process the part.

In some examples, control system 104 may compile and execute machine control codes, such as G-code data, that causes aspects of additive manufacturing machine 100 to operate. For example, the machine control codes may cause process motion system 112 or build surface motion system 124 to move to specific positions and at specific speeds. As another example, the machine control codes may cause directed energy source 106, material delivery system 108, gas delivery system 110, or cooling system 132 to activate or deactivate at specific times, locations, or based on specific conditions, such as operating conditions, sensor readings, and the like. Further, the machine control codes may modulate the operation (e.g., via a settable operational parameter) of the aforementioned aspects of additive manufacturing machine 100, such as by increasing or decreasing the power of directed energy source 106, increasing or decreasing the flow rate of material delivery system 108 or gas delivery system 110, increasing or decreasing amount of cooling by cooling system 132, etc., based on time, location, and/or conditions, such as operating conditions, sensor readings, and the like.

Process motion system 112 may move elements of additive manufacturing system 100 to specified positions. For example, process motion system 112 may position deposition element 120 at a specified distance from a part layer 122 being manufactured, or move deposition element 120 along a preprogrammed path to build up a three-dimensional part.

Additive manufacturing system 100 may include various sensors to monitor and to help control aspects of a manufacturing process through active feedback. In some embodiments, sensors 114 may be connected to process motion system 112 such that the sensors are configured to move with process motion system 112. For example, sensors 114 may include one or more temperature sensor, distance sensors, optical sensors (e.g., camera or video sensors), each of which may be configured to provide operational data during processing by additive manufacturing system 100. For example, temperature sensors may provide point temperature measurements, temperature gradients, heat maps, etc.

In some embodiments, a temperature sensor of sensors 114 may be any sort of sensor capable of measuring temperature to an object. In some examples, the temperature sensor 114 may include a contact-based sensor, such as a thermocouple, while in others, the temperature sensor may be a contact-less sensor, such as a photo or laser-based sensor. One or more temperature sensors may provide various types of temperature data back to control system 104, for example, to provide data for control of directed energy source 106, gas delivery system 110, and cooling system 132 to enable closed-loop control of directed actively cooled gas flows.

In some embodiments, sensors 114 may include various forms of optical sensors (e.g., image and/or camera sensors), such as a visible spectrum optical sensor, or a non-visible spectrum (e.g., infrared) optical sensor. In some examples, the same sensor may be able to provide data in multiple spectrums. Further, additive manufacturing system 100 may include optics that allow for directing, changing (e.g., zoom), and focusing a field of view of an optical sensor. Optical sensors may generally provide various types of image data, including infrared heat data, back to control system 104, for example, to provide data for control of directed energy source 106, gas delivery system 110, and cooling system 132 to enable closed-loop control of directed actively cooled gas flows. For example, an infrared-based optical sensors (e.g., an infrared image sensor) may be used to view heat distributions and gradients in part layers 122.

In some embodiments, various sensors, such as image sensors and contactless temperature and distance sensors, may be configured to have coaxial “views” of an active processing area 136, such as a melt pool created by deposition element 120. For example, a boresight camera or other sensor may be configured with optics that allow for “looking” down the directed energy axis (e.g., axis of beam 134) towards the part being manufactured, such as by using turning mirrors, one-way mirrors, and other optical elements.

Directed energy source 106 may provide any suitable form of directed energy, such as a laser beam (e.g., from a fiber laser) or an electron beam generator, which is capable of melting a manufacturing material, such as a metal powder. Directed energy source 106 may interact with directed energy guides 118 in order to, for example, direct or focus a particular type of directed energy. For example, directed energy guides 118 may comprise one or more optical elements, such as mirrors, lenses, filters, and the like, configured to focus a directed energy beam (e.g., laser beam) at a specific focal point (e.g., active processing area 136) and to control the size of the focal point. In this way, the actual creation of the directed energy beam by directed energy source 106 may be located remote from the manipulation and focusing of the directed energy by directed energy guides 118.

In some embodiments, directed energy source 106 may also be used to remove material from a manufactured part, such as by ablation.

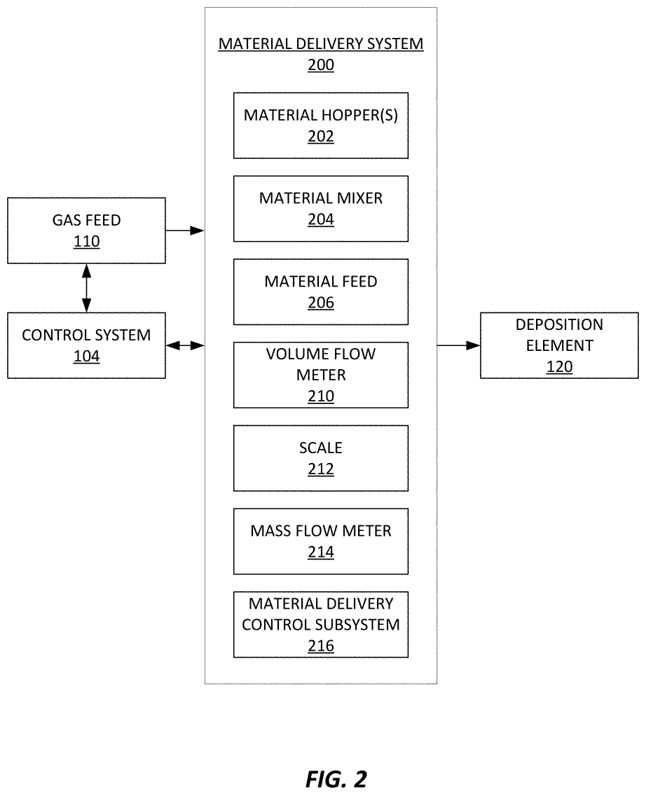

Material delivery system 108 may supply building material, such as a powder or wire, to deposition element 120. In some examples, material delivery system 108 may be a remote reservoir including one or more types of raw material (e.g., different types of metal) to be used by additive manufacturing system 100. Material delivery system 108 may be configured to provide one or more materials simultaneously to deposition element 120, such that hybrid materials (e.g., metal alloys) may be created in party layers 122. FIG. 2 describes an example of a material delivery system that may be used with additive manufacturing system 100.

Deposition element 120 may be connected with material delivery system 108 and may direct material, such as powder, towards a focal point of directed energy beam 134. In this way, material delivery system 108 may help control the amount of material that is additively manufactured at a particular point in time. Deposition element 120 may include nozzles, apertures, and other features for directing material, such as metal powder, towards a manufacturing surface, such as a build surface or previously deposited material layer. In some examples, deposition element 120 may have controllable characteristics, such as controllable nozzle aperture sizes. In some embodiments, deposition element 120 may be a nozzle assembly or deposition head of a laser metal deposition machine.

Gas delivery system 110 may be connected with deposition element 120 to provide propulsive force to the material provided by material delivery system 108, such as by use of carrier gas. In some examples, gas delivery system 110 may modulate the gas flow rate to control material (e.g., powder) flow through deposition element 120 and/or to provide cooling effect during the manufacturing process.

Gas delivery system 110 may include feeds for a plurality of gas flows, such as carrier gas (as described above) as well as shield gas and auxiliary gas flows, such as directed actively cooled gas flows. Gas delivery system 110 may also include feeds for different types of gases so that, for example, different gases may be used for carrier gases, shield gases and auxiliary gases. Gas delivery system 110 may further be configured to provide different gas flows at different rates under the control of control system 104.

Gas delivery system 110 may also be connected with cooling system 132, which may actively cool any of the gas aforementioned gas flows (e.g., carrier, shield, and auxiliary). Cooling system 132 may be configured to apply different amounts of cooling to different gases under the control of control system 104.

Notably, while directed energy source 106, material delivery system 108, gas delivery system 110, sensors 114, sensors 116, directed energy guides 118, and deposition element 120 are shown in an example configuration in FIG. 1, other configurations are possible.

Process motion system 112 may control the positioning of one or more aspects of additive manufacturing system 100, such as sensors 114, sensors 116, and deposition element 120. In some examples, process motion system 112 may be movable in one or more degrees of freedom (e.g., three to six degrees of freedom). For example, process motion system 112 may move and rotate deposition element 120 in and about the X, Y, and Z axes during the manufacturing of part layers 122.

Though not depicted, in various embodiments, process motion system 112 may include cooling elements, such as cooling tubes, fins, channels, lines, and the like. In some embodiments, cooling system 132 may be configured to actively control the temperature of (e.g., to cool) process motion system 112, or parts thereof, such as sensors 114.

Build surface motion system 124 may control the positioning of, for example, a build surface upon which part layers 122 are manufactured. In some examples, build surface motion system 124 may be movable in and about one or more degrees of freedom. For example, build surface motion system 124 may move and rotate the build surface in and about the X, Y, and Z axes during the manufacturing of part layers 122. In some examples, the build surface may be referred to as a build plate or build substrate.

Build surface motion system 124 may also comprise sensors 116, which may include, for example, load sensors, temperature sensors, position sensors, and other sensors that may provide useful information to control system 104. For example, a temperature sensor within build surface motion system may cause control system 104 to increase cooling via cooling system 132, or to decrease power to a directed energy source, and the like.

Though not depicted, in various embodiments, build surface motion system 124 may include cooling elements, such as cooling tubes, fins, channels, and the like. In some embodiments, cooling system 132 may be configured to actively control the temperature of (e.g., to cool) build surface motion system 124, or parts thereof, such as a substrate of build surface motion system 124.

Cooling system 132 may be any sort of active cooling system, such as refrigeration system, a vortex cooler, evaporative gas cooling system, heat pump, and others. Active cooling generally refers to taking an input coolant medium (e.g., fluid or gas) and extracting heat from that coolant medium such that the output coolant medium has a lowered temperature.

Computer-Aided Design (CAD) software 126 may be used to design a digital representation of a part to be manufactured, such as a 3D model. CAD software 126 may be used to create 3D design models in standard data formats, such as DXF, STP, IGS, STL, and others. While shown separate from additive manufacturing system 100 in FIG. 1, in some examples CAD software 126 may be integrated with additive manufacturing system 100.

Slicing software 130 may be used to “slice” a 3D design model into a plurality of slices or design layers. Such slices or design layers may be used for the layer-by-layer additive manufacturing of parts using, for example, additive manufacturing system 100.

Computer-Aided Manufacturing (CAM) software 128 may be used to create machine control codes, for example, G-Code, for the control of additive manufacturing system 100. For example, CAM software 128 may create code in order to direct additive manufacturing system 100 to deposit a material layer along a 2D plane, such as a build surface, in order to build or process a part. For example, as shown in FIG. 1, part layers 122 are manufactured on (e.g., deposited on, formed on, processed on, etc.) build surface motion system 124 using process motion system 112 and deposition element 120.

In some examples, one or more of CAD software 126, CAM software 128, and Slicing Software 130 may be combined into a single piece or suite of software. For example, CAD or CAM software may have an integrated slicing function.

### Example Material Delivery Subsystem

FIG. 2 depicts an example of a material delivery system 200. For example, material delivery subsystem 200 may be an example of material delivery system 108 in FIG. 1.

Material delivery system 200 comprises one or more material hoppers 202 having corresponding hopper outputs to contain and continuously feed material, such as powdered build materials (e.g., metal powders), to a downstream portion of an additive manufacturing system, such as to deposition element 120. In some embodiments, material hopper 202 is a pressurized material hopper that is connected to gas delivery system 110, such as described with respect to FIG. 1. Any suitable number of material hoppers 202 may be used in material delivery system 200 and each may include the same or a different powder than each of the other material hoppers. Any suitable material may be utilized, such as a metal powder, a ceramic powder, or metal matrix composite powder, to name just a few.

Material delivery system 200 may also include a material mixer 204. For example, where multiple material hoppers 202 are used to create mixed materials for deposition, material mixer 204 may be used to improve the consistency of the material mixture. For example, material mixer 204 may comprise a stir mixer or a vibratory mechanism to maintain flow consistency.

Material delivery systems 200 may also include a material feed 206 configured to control the flow of material from material hopper 202 (or material mixer 204) to downstream portions of an additive manufacturing apparatus, such to deposition element 120. Material feed 206 may be of any suitable type, such as a gravity fed feeder, pressurized feeder, disc-type feeder, vibratory feeder, or screw-fed feeder so long as the material may be satisfactorily contained and continuously fed to the downstream portion of an additive manufacturing system.

Material delivery systems 200 may also include a volume flow meter 210 configured to measure the volume of material flow from material delivery system 200 to downstream portions of an additive manufacturing device, such as to deposition element 120.

In one embodiment, volume flow meter 210 comprises an optical material flow meter configured to determine a volumetric feeding rate of material from material delivery system 200. Generally, an optical material flow meter may include a collimated and/or expanded light (e.g., laser light) beam and an optical sensor configured to detect the light. In some embodiments, the light beam is directed through a material flow towards the optical sensor such that a density of the material flowing through the system scatters the light beam and changes the amount of light impinging on the optical sensor. The amount of light received by the optical sensor thus decreases or increases as the material flow increases or decreases. In some embodiments, the optical sensor is configured to output a voltage based on the amount of light received by the optical sensor. The volumetric feeding rate of the material may be determined from the voltage output of optical sensor through, for example, a calibration process.

Material delivery systems 200 may also include a mass flow meter 214 configured to measure the mass of material flow to, for example, deposition element 120. For example, in one embodiment, mass flow meter 214 converts an analog (e.g., voltage) output from scale 212 and determines a corresponding mass-flow rate. In another embodiment, the output from scale 212 may be a digital signal.

In an alternative embodiment, scale 212 may output an analog or digital signal directly to material delivery control subsystem 216 or to control system 104, either of which may, in-turn, calculate the mass flow rate based on the output signal from scale 212.

Material delivery systems 200 may also include a material delivery control subsystem 216 in some embodiments. In such embodiments, material delivery control subsystem 216 may interface with local elements of material delivery system 200 and provide a data and control link to overall control system 104. In some embodiments, a standard data protocol may be implemented between control system 104 and material delivery control subsystem 216. In this way, material delivery system 200 may be a modular component able to be added to any additive manufacturing system, include system 100 described with respect to FIG. 1, with minimal changes to the existing additive manufacturing system. For example, an existing additive manufacturing system may only need to implement instructions consistent with a protocol for material delivery system 200 without needing special programming (e.g., machine-level instructions) to interoperate with material delivery system 200.

However, in other embodiments, material delivery control subsystem 216 may be omitted, and control of material delivery system 200 may be implemented in control system 104.

In either control architecture, material feed 206 may be controlled based on feedback from flow meters, such as volume flow meter 210 and mass flow meter 214. For example, a proportional-integral-derivative (PID) control loop may be implemented to increase/decrease a material feed date via material feed 206 in order to provide a constant material mass flow to downstream elements of the additive manufacturing process, such as deposition element 120.

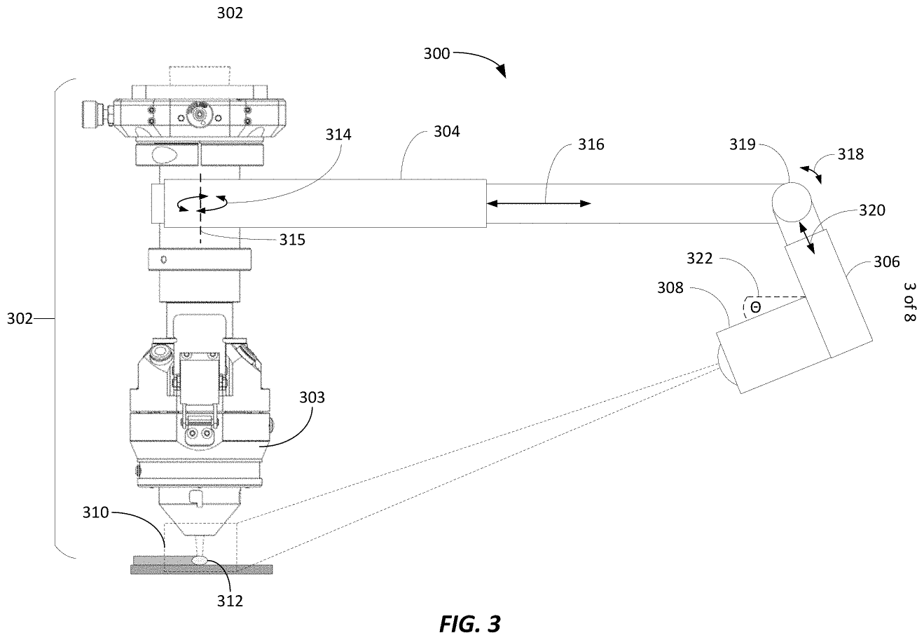

With the inclusion of a very accurate scale 212, such as a SAW scale, material delivery system 200 is able to accurately measure mass flow based on changes in measured weight over time, rather than by deriving the mass flow based on volume flow measurements (e.g., from volume flow meter 210) and assumptions regarding the weight per unit volume of the flowing material. For example, as described in more detail below with respect to FIG. 3, the PID control scheme may control the speed of a disc-based material feeder in order to control the mass flow rate.

In some embodiments, one of the flow meters, such as the mass flow meter 214, may be used as a primary flow control signal (or data) source, while the other flow meter, which in this example is volume flow meter 210, may be used as a check for system redundancy. In other embodiments, both mass flow meter 214 and volume flow meter 210 may be used as flow control signals. In some cases, divergence or differences between the flow measurement types (e.g., volume-based mass approximation) and mass flow may indicate a fault in the system (such as a clogged feed line) that should be checked before additional manufacturing.

### Active Working Distance Measurement

FIG. 3 depicts an example of an additive manufacturing machine with a working distance measurement system 300.

Deposition assembly 302 may generally be part of an additive manufacturing system, such as 100 described above with respect to FIG. 1, and deposition head 303 is an example of a deposition element 120, as described above with respect to FIG. 1. Note that other aspects of the additive manufacturing system are omitted for clarity.

In this example, working distance measurement system 300 includes a horizontal extension element 304 that is connected to deposition assembly 302 and configured to laterally extend camera 308 away from deposition assembly 302. Note that the particular point of attachment in this example is just one example, and many other points of attachment to aspects of an additive manufacturing system, such as to aspects of a process motion system) are possible. Further in this example, horizontal extension element 304 is adjustable in extension (or projection) from deposition assembly 302 in the directions indicated by arrow 316. However, in other embodiments, horizontal extension element 304 could be a fixed length extension.

Horizontal extension element 304 is also configured to rotate around axis 315, as depicted by arrows 314, in this example. This rotation allows camera 308 to be moved around the active processing area 312 and to account for possible obstructions in the manufacturing volume (e.g., within a closed additive manufacturing chamber). In other embodiments, horizontal extension element 304 may be attached to deposition assembly 302 without the ability to rotate.

Working distance measurement system 300 further includes a hinge 319 connecting horizontal extension element 314 to vertical extension element 306, and allowing rotation of vertical extension element 306 relative to horizontal extension element 304, such as depicted by arrow 318. This rotation allows camera 308 to be directed at active processing area 312 at different extensions of horizontal extension element 308.

Like horizontal extension element 304, vertical extension element 306 is also configured to extend along the directions of arrow 320.

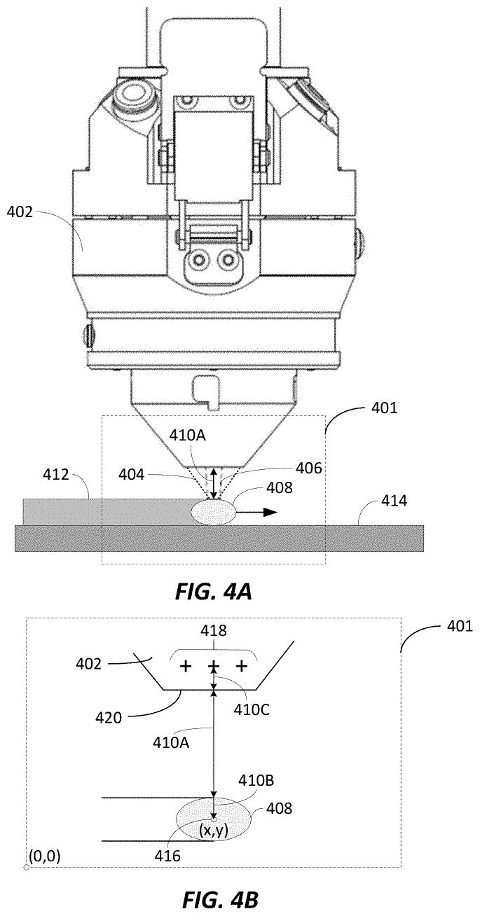

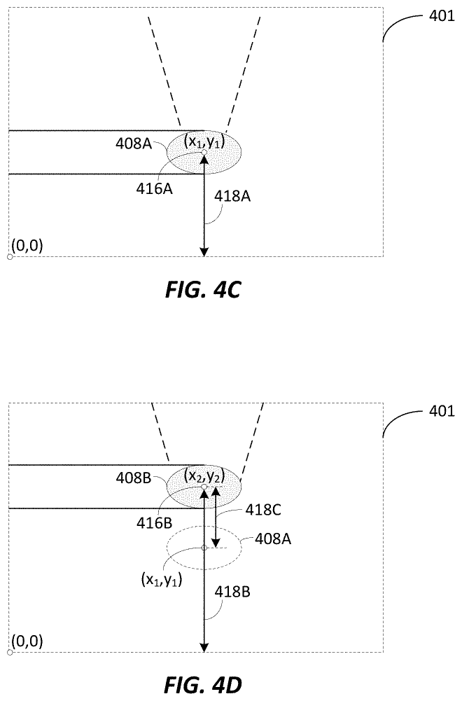

Horizontal extension element 304, joint 319, and vertical extension element 306 are each generally configured to allow positioning of camera 308 such that camera 308 has a field of view 310 encompassing active processing area 312 and at least a portion of deposition head 303. As will be described in more detail with respect to FIGS. 4A-4B, this allows for actively determining the working distance between the deposition head 303 and the active processing area 312.

In some embodiments, one or more of the extension and rotation of horizontal extension element 304, the angle of joint 319, and the extension of vertical extension element 306, may be manually adjustable, such as by manually articulating any of these adjustment elements in the directions indicated by the arrows (e.g., 314, 316, 318, and 320) and then fixing it into place by a fixing means, such as a set screw, clamp, locking pin, friction fit, or the like. In other embodiments, any of these adjustment elements may be articulated under control of an electronic control system (not depicted), such as control system 104 of FIG. 1, or a standalone control system in communication with control system 104. For example, horizontal extension element 304 and vertical extension element 306 may be electronically, magnetically, pneumatically, or otherwise programmatically actuated based on commands received from an electronic control system. Similarly, horizontal extension element 304 and vertical extension element 306 may be rotated by electronic, pneumatic, or otherwise programmatic actuation.

Beneficially, adjusting camera 308 (whether manually or automatically) provides a way to reliably and repeatedly optimize the field of view for camera 308 so that a working distance between deposition head 303 and the active processing area 312 may be reliably determined. Because working distance measurement system 300 is rigidly affixed to deposition assembly 302 in this example, camera 308 moves with deposition assembly 302 as it is manipulated by, for example, a process motion system, such as 112 in FIG. 1, and thus maintains its field of view during processing.

In some embodiments, camera 308 may include a zoom capability, which may be electrical and/or optical, and which may be beneficial for setting an optimal field of view (e.g., 310) after camera 308 has been moved into position. Generally, an optimal field of view may be one that includes a clear view of the active processing area (e.g., 312) and at least a portion of a deposition element (e.g., 303) such that a distance between the two may be clearly seen and determined. In some embodiments, the optimal field of view is set as the maximum zoom or resolution of the working distance, which still includes both the active processing area 312 and a targeted portion of the deposition element, such as a portion of the deposition element that may be recognized by a computer vision model.

In some embodiments, the angle 322 of camera 308 relative to the horizon may generally be an acute angle, and in some embodiments may be set to 45 or fewer degrees of declination in order to maintain a sufficient side-on view of the active processing area 312. In some embodiments, 30 or fewer degrees is preferable to improve the field of view for working distance measurement and to reduce parallax distortion.

When one or more of the positioning elements (e.g., 304, 319, and 306) of active working distance measurement system 300 is remotely controllable (e.g., programmatically), the working distance measurement system 300 may beneficially be programmed to provide the best field of view while also avoiding obstructions and contacts with other aspects of the additive manufacturing machine or the additive manufacturing environment, such as within a closure in which the additive manufacturing is taking place. For example, the extension members may be moved to avoid other parts of an additive manufacturing system, such as the enclosure, actuators, coolant and material lines, and the like, in addition to the part itself

In some embodiments, camera 308 may be configured to provide image data to an electronic control system configured to detect and track an active processing area, and thereafter to provide active feedback to the electronic control system to cause controllable positioning elements of active working distance measurement system 300 to adjust to provide the best possible field of view. In some embodiments, the image data may be based on the visible light spectrum, while in others it may be based on other spectra of light, such as infrared light. In some embodiments, camera 308 may be a depth-sensing camera configured to estimate the position of an object in a three-dimensional space and provide that position back to a control system, such as control system 104 of FIG. 1.

In some embodiments, the location of camera 308 and angle 322 of camera 308 may be determined by the additive manufacturing system. For example, the three-dimensional coordinate location within a build volume, which may be the same volume referenced by the additive manufacturing system when building a part, may be determined based on knowing the position of deposition assembly 302, the length of the horizontal extension element 304, the length of the vertical extension element 306, and the angle 308 of the camera 322, which may match an angle of rotation ofjoint 319. In some embodiments, these distances and angles may be determined by precise motion encoders on each of the adjustable elements (not shown) so that when they are adjusted, whether manually or through programmatic control, updated locations are determined by the system. With all of these locations and angles known, it is possible to determine an estimated location of the active processing area 312 in a two- or three-dimensional coordinate system, and to determine a working distance between the deposition head 303 through trigonometric calculations.

Further, in another embodiment, camera 308 may include a range finding capability, such as by an integral LiDAR sensor. Alternatively, a range-finding sensor, such as a LiDAR sensor, may be positioned with or attached to camera 308 to provide the same function. As above, in some cases, camera 308 may have inherent range-finding capability, such as in the case of a depth-sensing camera.

FIGS. 4A and 4B depict further aspects of determining a working distance between a deposition element 402 (e.g., a deposition head) and an active processing area 408 (e.g., a melt pool).

In particular, FIG. 4A depicts deposition element 402 depositing a layer of new material 412 along the direction of the arrow 418 on an existing layer or substrate 414. Powdered material 404 is projected in towards the active processing area 408 (a melt pool in this example), which is created by the intersection of the directed energy beam 406 and the powder flow 404.

Box 401 is representative of a field of view of a camera (such as camera 308 in FIG. 3), which clearly shows a working distance 410A between a reference point (or feature) on deposition element 402 (e.g., the flat bottom surface of the deposition element) and active processing area 408.

FIG. 4B depicts additional aspects of determining a working distance based on field of view 401. As depicted, different types of working distance can be determined in different ways based on the same image data (e.g., from a camera).

In a first embodiment, a working distance between the bottom surface 420 of deposition element 402 and a top or approximately highest portion of the active processing area 408 is depicted by the arrow 410A. In some embodiments, the image data provided by the camera may be processed using computer vision techniques and/or machine learning models to determine the working distance depicted by arrow 410A. For example, a detected portion of the active processing area 408 that is closest to a detected edge of the bottom of deposition element 402 may be used to determine the working distance, either relatively, or absolutely (e.g., in a standard measure, such as mm, inches, etc.).

In a second embodiment, a working distance between the bottom surface 420 of deposition element 402 and a center or centroid of the active processing area 408 is depicted by the arrows 410A and 410B together. As above, the image data provided by the camera may be processed using computer vision techniques and/or machine learning models to identify the center or centroid of active processing area 408 and the bottom surface 420 of deposition element 402 to determine this working distance. As further depicted, a coordinate position of any detected feature in field of view 401, such as centroid 416 at coordinates (x, y), may be determined relative to a reference in field of view 401, such as a corner (e.g., the bottom-left corner with coordinates 0,0). In some embodiments, the coordinates may be scaled so as to provide a reference for actual distances depicted in field of view 401.

In a third embodiment, a working distance between a target marker 418 of deposition element 402 (e.g., on a nozzle of the deposition element in this example) and either the top of active processing area 408, or the centroid of active processing area 408, may be determined, such as depicted by the arrows 410A, 410B, and 410C. Target markers 418 may be added to deposition element 302, such as by laser engraving, printing, or other suitable marking, so that a camera system and/or a computer vision model can easily identify the target marker. For example, a computer vision model may be more easily trained to more reliably determine a known target marker shape than other features of a deposition assembly, which may be affected by viewing orientation. Where the distance between target marker 418 and the bottom surface 420 of deposition element 402 is known, then the distance indicated by arrow 410C may be used to determine relative working distances.

For example, if the camera detects target marker 418 and centroid 416 and a distance is determined there-between, the known distance between target marker 418 and the bottom of deposition element 402 (indicated by arrow 410C) can be subtracted to determine the actual working distance.

Further, when the positions of target markers 418 is known, such as the distance between the target markers, the target markers may be used as a distance reference for an image sensor or computer vision model. Therefore, by determining the distance between target markers in different fields of view (e.g., at different distances or zooms), other distances may be calculated more precisely, such as the distances represented by arrows 410A-C. Note that the shape and arrangement of target markers 418 are just one example, and any suitable shape or location could be used.

As above, actively determining the working distance may be very beneficial to an additive manufacturing operation. For example, the working distance may provide active feedback to a control system (e.g., control system 104 in FIG. 1) regarding the build rate of a part being built (e.g., distance/height per layer, such as mm/layer). In some cases, a local layer height may be determined, which is proximate to the active processing area (e.g., within a threshold distance), as compared to an average layer height across the entire deposited layer. This real-time build rate determination may be used to adjust operational parameters of the additive manufacturing machine, such as directed energy power, material flow rate, gas flow rates, active cooling, and the like, in order to achieve a desired build rate, heating profile, and the like. For example, a material flow rate may be increased to increase the layer height, or vice versa.

The working distance may also provide an active reference for the current height of the part being built, which may improve the control system's selection of a next layer to be built, for example, such as in the case of an active layer selection system as described in U.S. Pat. No. 10,569,522, entitled “Dynamic Layer Selection In Additive Manufacturing Using Sensor Feedback”, which is incorporated by reference herein in its entirety.

In some embodiments, the determined working distance (e.g., between the bottom surface 420 of deposition element 402 and either the top surface or centroid of active processing area 408) may be determined relatively, such that changes in the working distance are used for control of the additive manufacturing process, but actual distance (e.g., in mm) is not known. In other embodiments, the actual distance may be determined, which may provide additional process parameters for control of the additive manufacturing process.

For example, as depicted in FIG. 4C, a first reference distance 418A may be based on a distance from an edge of field of view 401, such as the top edge or bottom edge (in this example, the bottom edge), to a portion of the active processing area 408A, such as centroid 416A in this example. Here the reference distance 418A is calculable based on the coordinate y₁ , which represents the distance of a perpendicular line between the edge at y=0 and centroid 416A at y=y₁. Similarly, a reference distance from the top of field of view 401 may be calculated according to dist=yₘₐₓ−y₁, where yₘₐₓ represents they value at the top edge of field of view 401.

FIG. 4D depicts a second reference distance 418B based on the distance from the bottom edge of field of view 401 to centroid 416B of active processing area 408B. Active processing area 408A from FIG. 4C is shown in broken lines as a reference to show how the current active processing area 408B has changed in relative position. Because the camera is rigidly attached to the deposition element, such as in FIG. 3, the change in relative position of active processing area 408B allows for determining (or inferring) that the working distance between the deposition element and active processing area 408B is reduced in this example. In particular, the relative change to the working distance is depicted by line 418C, which may be calculated as Δ_{dist}=y₂−y₁. Similarly, if active processing area 408B was instead below active processing area 408A (not depicted in FIG. 4D), then it may be determined that the working distance between active processing area 408B and the deposition element has increased. Thus, a control system, such as 104 in FIG. 1, may use relative changes in detected active processing area location to determine changes to working distance and control for these changes without necessarily having to “see” the deposition element.

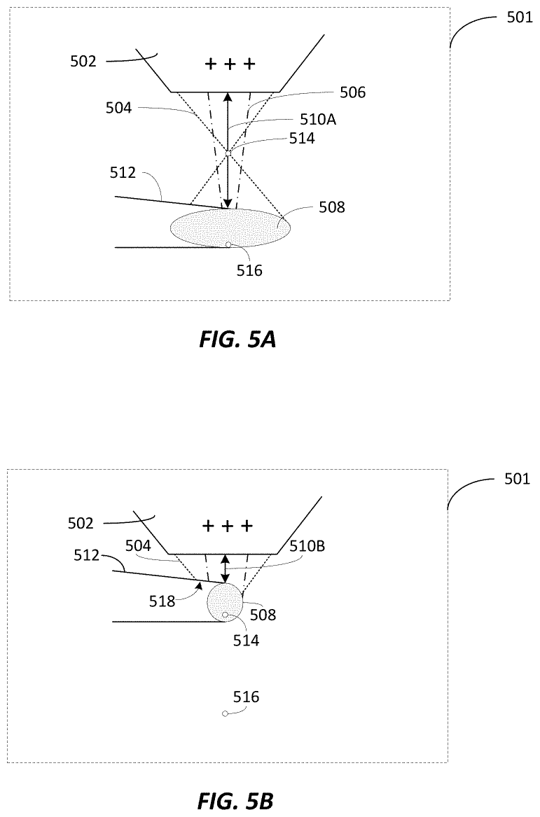

FIGS. 5A and 5B depict examples of working distance errors that may be mitigated by active working distance measurements, such as by the system described with respect to FIGS. 3 and 4, above.

In particular, FIG. 5A demonstrates an example of a working distance 510A that is longer than optimal such that the focal point 514 of the material flow 504 (e.g., powder flow) and the focal point 516 of the energy beam 506 (e.g., a laser beam) do not coincide. Note that the focal point 514 of the material flow 504 may generally be known based on physical characteristics of deposition element 502, and the focal point 516 of energy beam 506 may be based on a desired spot size, rather than a point. Further, focal point 516 of energy beam 506 may be adjustable based on, for example, adjustable optical elements in a deposition assembly, such as deposition assembly 302 in FIG. 3.

Suboptimal working distance 510Amay cause poor adhesion to build surface 512 (e.g., a layer being deposited on a part), poor uniformity or quality of build surface 512, and wasted material. As depicted in this example, the top surface of build surface 512 is not parallel with the bottom surface (e.g., unintentionally non-uniform), which not only affects the present layer being built, but also any layers being built upon build surface 512. Further, as the material flow converges at point 514, it will begin to interfere with itself (e.g., through turbulence induced in the flows) and build material will be scattered, which may cause further loss of material and inconsistent application of the material to the build surface.

FIG. 5B demonstrates an example of a working distance 510B that is shorter than optimal, wherein again the focal point 514 of the material flow 504 (e.g., powder flow) and the focal point 516 of the energy beam 506 (e.g., a laser beam) do not coincide. Potential consequences of suboptimal working distance 510B are a reduction in powder efficiency and reduced surface finish quality.

In both FIGS. 5A and 5B, the field of view 501 of a camera system, such as 308 described above with respect to FIG. 3, is depicted. As above, the field of view created by a laterally offset camera gives a beneficial viewing angle that allows for the working distances 510A and 510B to be determined and remedied through active control of the additive manufacturing system, such as through control of operational parameters of the system.

In some embodiments, the working distance may be actively adjusted based on the determined working distance by causing a process motion system (e.g., 112 in FIG. 1) to move deposition element 502 closer to the build surface in the case of FIG. 5A, or farther from the build surface in the case of FIG. 5B. As another alternative, the working distance may be adjusted by moving a build surface motion system (e.g., 124 in FIG. 1) closer or farther from deposition element 502. In yet another alternative, the working distance may be adjusted without adjusting the position of deposition element 502 by adjusting a focal point of energy beam 506, such as through optical elements in the deposition assembly (e.g., such as described with respect to directed energy guides 118 in FIG. 1). In a further alternative, a material flow may be increased, which will increase the thickness (or height) of the active processing area (e.g., the melt pool) and thereby reduce the working distance, or the material flow may be decreased, which will decrease the thickness (or height) of the active processing area and thereby increase the working distance. These are just some examples, and others are possible.

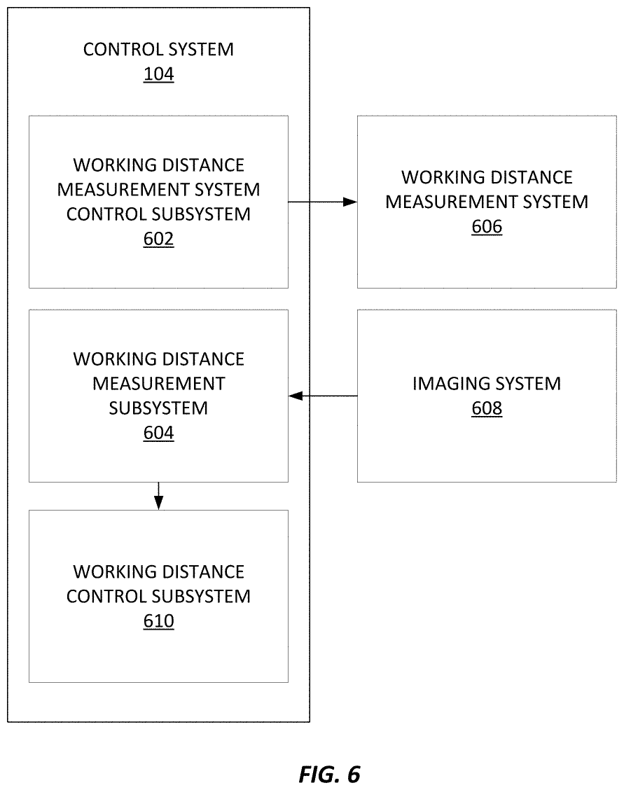

FIG. 6 depicts aspects of control system 104 of FIG. 1 configured for measuring working distance and acting upon measured working distance.

In the depicted example, control system 104 includes a working distance measurement control subsystem 602, which may be configured to control adjustable elements of a working distance measurement system 606, such as described above with respect to FIG. 3.

Control system 104 further includes a distance measurement subsystem 604. In some embodiments, working distance measurement subsystem 604 may include models for determining a working distance based on image data received from imaging system 608. For example, the models may include computer vision models configured to detect features in a field of view, such as an active processing area, a layer, an edge of a deposition element, or another feature of a deposition element, such as a target marker. In some embodiments, the active processing area, as well as a centroid, width, height, area, and other features may be determined based on computer vision techniques, such as edge detection based on pixel brightness, contrast, etc. For example, the active processing area may be brighter than the surrounding areas in both the visual light and infrared light spectrum. These are just some examples, and others are possible.

The computer vision models may also be configured to determine distances (relative or absolute) between detected features. In some embodiments, the computer vision models may include convolutional neural network models, designed to detect features in the field of view. The models may further include mathematical models, such as trigonometrical models for estimating positions based on known positions and angles, and distance estimation models based on features identified in image data and, in some cases, known positions and sizes of various aspects of an additive manufacturing machine. These are just some examples, and others are possible.

The output of working distance measurement system 604 may be measurement data (e.g., a relative or absolute measurement of the working distance), which is used as an input to working distance control system 610. Working distance control system 610 may then control other aspects of an additive manufacturing system based on the measurement, including a directed energy source (e.g., 106 in FIG. 1) and/or related optical elements (e.g., 118 in FIG. 1), a material deliver system (e.g., 108 in FIG. 1), a gas delivery system (e.g., 110 in FIG. 1), a cooling system (e.g., 132 in FIG. 1), a process motion system (e.g., 112 in FIG. 1), a build surface motion system (e.g., 124 in FIG. 1), to name a few.

### Example Method of Additive Manufacturing with a Working Distance Measurement System

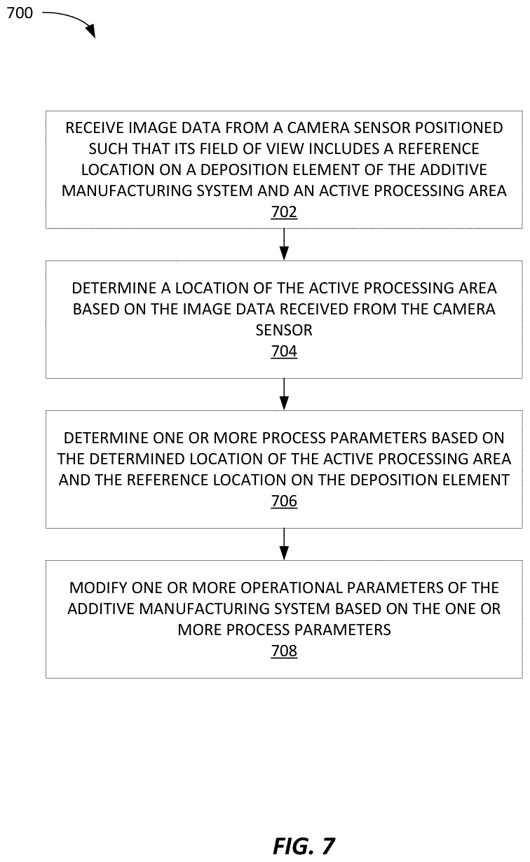

FIG. 7 depicts an example method of operating an additive manufacturing system with a working distance measurement system (such as system 300 described above with respect to FIG. 3).

Method 700 begins at step 702 with receiving image data from a camera sensor positioned such that its field of view includes a reference location on a deposition element of the additive manufacturing system and an active processing area.

Method 700 then proceeds to step 704 with determining a location of the active processing area based on the image data received from the camera sensor.

Method 700 then proceeds to step 706 with determining one or more process parameters based on the determined location of the active processing area and the reference location on the deposition element. In some embodiments, the one of the one or more process parameters comprises at least one of: a working distance between the active processing area and5 the reference location on the deposition element; a location of the active processing area in a two- or three-dimensional coordinate reference system; a local height of a layer of material being deposited by the additive manufacturing apparatus; or a current height of a part being built by the additive manufacturing apparatus.

Method 700 then proceeds to step 708 with modifying one or more operational parameters of the additive manufacturing system based on the one or more determined process parameters. The operational parameters may include, for example, a position of the process motion system, a speed of the process motion system, a position of the build surface motion system, a material flow (or feed) rate, a gas flow rate, a cooling setting, a directed energy power setting, a directed energy guide setting (e.g., a position of an optical element, and others as described herein.

Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An additive manufacturing apparatus, comprising:
a process motion system configured to move in a plurality of degrees of freedom;
a deposition assembly connected to the process motion system and comprising a deposition element;
a working distance measurement assembly attached to the deposition assembly; and
a controller configured to control operation of the additive manufacturing apparatus,
wherein:
the working distance measurement assembly comprises a camera sensor positioned such that its field of view includes a reference location on the deposition element and an active processing area,
the controller is configured to determine a location of the active processing area based on image data received from the camera sensor, and
the controller is further configured to determine one or more process parameters based on the determined location of the active processing area and the reference location on the deposition element.

2. The additive manufacturing apparatus of claim 1, wherein the working distance measurement assembly comprises:
a rigid extension member connected to and projecting outward from the deposition assembly; and
the camera sensor mounted at a distal end of the rigid extension member.

3. The additive manufacturing apparatus of claim 2, wherein:
the additive manufacturing apparatus comprises a laser metal deposition apparatus, and
the rigid extension member is approximately perpendicular to a laser axis of the deposition assembly.

4. The additive manufacturing apparatus of claim 2, wherein the camera sensor is mounted at an angle of less than 30 degrees with respect to the rigid extension member.

5. The additive manufacturing apparatus of claim 1, wherein the reference location on the deposition element comprises a flat lower surface of a deposition nozzle of the deposition element.

6. The additive manufacturing apparatus of claim 1, wherein the reference location on the deposition element comprises a target marker on a deposition nozzle of the deposition element.

7. The additive manufacturing apparatus of claim 1, wherein one of the one or more process parameters comprises a location of the active processing area in a two-dimensional coordinate plane.

8. The additive manufacturing apparatus of claim 7, wherein the location of the active processing area comprises a centroid of the active processing area.

9. The additive manufacturing apparatus of claim 8, wherein the active processing area comprises a melt pool.

10. The additive manufacturing apparatus of claim 1, wherein one of the one or more process parameters comprises a working distance between the active processing area and the reference location on the deposition element.

11. The additive manufacturing apparatus of claim 1, wherein one of the one or more process parameters comprises a local height of a layer of material being deposited by the additive manufacturing apparatus.

12. The additive manufacturing apparatus of claim 1, wherein one of the one or more process parameters comprises a current height of a part being built by the additive manufacturing apparatus.

13. The additive manufacturing apparatus of claim 1, wherein the controller is further configured to control a movement of the process motion system based on the determined one or more process parameters.

14. The additive manufacturing apparatus of claim 1, wherein the controller is further configured to control a material flow rate based on the determined one or more process parameters.

15. The additive manufacturing apparatus of claim 1, wherein the controller is further configured to control a directed energy power setting based on the determined one or more process parameters.

16. The additive manufacturing apparatus of claim 1, wherein the controller is further configured to move the camera sensor using one or more adjustable extension elements of the working distance measurement assembly.

17. A method of operating an additive manufacturing system, comprising:
receiving image data from a camera sensor positioned such that its field of view includes a reference location on a deposition element of the additive manufacturing system and an active processing area;
determining a location of the active processing area based on the image data received from the camera sensor; and
determining one or more process parameters based on the determined location of the active processing area and the reference location on the deposition element.

18. The method of claim 17, wherein one of the one or more process parameters comprises a working distance between the active processing area and the reference location on the deposition element.

19. The method of claim 18, further comprising: adjusting one or more operational parameters of the additive manufacturing system based on the working distance.

20. The method of claim 19, wherein at least one of the one or more operational parameters comprises:
a position of a process motion system;
a speed of the process motion system;
a material flow rate; or
a directed energy power setting.

21. A method of operating an additive manufacturing system, comprising:
receiving image data from a camera sensor positioned such that its field of view includes an active processing area;
determining a location of the active processing area based on the image data received from the camera sensor; and
determining one or more process parameters based on the determined location of the active processing area.

22. The method of claim 21, wherein one of the one or more process parameters comprises a reference distance between the active processing area and an edge of a field of view of the camera sensor.

23. The method of claim 22, further comprising: adjusting one or more operational parameters of the additive manufacturing system based on the reference distance.

24. The method of claim 23, wherein at least one of the one or more operational parameters comprises:
a position of a process motion system;
a speed of the process motion system;
a material flow rate; or
a directed energy power setting.
